(19) United States
(12) Patent Application Publication
(10) Pub. No.: US 2024/0370975 A1
(43) Pub. Date: Nov. 7, 2024

(54) IMAGE ADJUSTMENT METHOD, PROGRAM AND IMAGE ADJUSTMENT DEVICE

(71) Applicant: NIPPON TELEGRAPH AND TELEPHONE CORPORATION, Tokyo (JP)

(72) Inventors: Yongqing SUN, Musashino-shi, Tokyo (JP); Xiaomeng WU, Musashino-shi, Tokyo (JP); Akisato KIMURA, Musashino-shi, Tokyo (JP); Kunio KASHINO, Musashino-shi, Tokyo (JP)

(73) Assignee: NIPPON TELEGRAPH AND TELEPHONE CORPORATION, Tokyo (JP)

(21) Appl. No.: 18/270,894

(22) PCT Filed: Jan. 12, 2021
(86) PCT No.: PCT/JP2021/000611

§ 371 Date: Jul. 5, 2023

(51) Int. Cl. G06T 5/40; G06T 5/92; H04N 23/70

(52) U.S. Cl. CPC G06T 5/40; G06T 5/92; H04N 23/70

(57) ABSTRACT

One aspect of the present invention is an image adjustment method including: deriving a statistic from a first pixel having a first luminance and a second pixel having a second luminance co-occurring in a local region in an input image, and deriving a two-dimensional luminance histogram having the statistic as a numerical value corresponding to the first luminance and the second luminance; deriving a numerical value by weighting the two-dimensional luminance histogram by using a weighting coefficient determined according to a third luminance greater than the first luminance and less than or equal to the second luminance, and deriving a one-dimensional luminance histogram having the numerical value as a numerical value corresponding to the third luminance; and deriving a luminance conversion function to cause the one-dimensional luminance histogram derived to be converted into a predetermined histogram, and converting a luminance of each of pixels of the input image by using the luminance conversion function.

### TECHNICAL FIELD

The present invention relates to a technique of an image adjustment method, a program, and an image adjustment device.

### BACKGROUND ART

In recent years, as digital cameras, smartphones, and the like are widely used, the number of images captured every day is becoming enormous. With such a background, there is a significant increase in demand for image enhancement that is one of image editing. To obtain satisfactory results by using commercially available image editing software, image editing expertise or a lot of manual work is required. Thus, it is important to implement automatic image enhancement adaptable to images captured in various imaging environments.

Histogram equalization, which is one of conventional image enhancement methods, has attracted the most attention due to intuitive implementation quality and high efficiency. The histogram equalization derives a luminance conversion function that converts luminance of an input image into luminance of an output image so that a luminance distribution of the output image output after editing the input image is a uniform distribution.

Specifically, in the histogram equalization, a one-dimensional luminance histogram that is a luminance distribution of an input image is constructed, and a luminance conversion function is derived on the basis of a cumulative distribution function of the one-dimensional luminance histogram. The histogram equalization has shown utility in some applications.

However, the one-dimensional luminance histogram used by the histogram equalization is a distribution of frequency at which luminance appears in the input image. For that reason, even in an image region that is not semantically important, such as a background without texture or quantization noise of an image, there is a problem that contrast is excessively enhanced in a region having a large amount of similar luminance. This problem is addressed by embedding gradient information of the image into the one-dimensional luminance histogram. Note that examples of the semantically important image region include a region in which a main subject is captured (or a region other than the background).

For example, in a technique disclosed in Patent Literature 1, a luminance gradient of an image is calculated as importance of a pixel, and a new one-dimensional luminance histogram weighted by the importance of the pixel is constructed. By equalizing the new one-dimensional luminance histogram, it is possible to suppress excessive enhancement of the contrast for the image region that is not semantically important.

### CITATION LIST

### Patent Literature

Patent Literature 1: JP 2019-16117 A

### SUMMARY OF INVENTION

### Technical Problem

However, for luminances that frequently co-occur in a local region of an image, the technique disclosed in Patent Literature 1 may overestimate the importance of pixels having these luminances. Thus, in a case where a very small (dark) luminance and a very large (bright) luminance frequently co-occur in a local region of the image, these luminances tend to be converted to be excessively drawn to the center of a luminance range.

As a result, there is a problem that the contrast near the center of the luminance range may be attenuated or the quantization noise of the image may be enhanced.

In view of the above circumstances, an object of the present invention is to provide a technique capable of more suitably editing an image.

### Solution to Problem

One aspect of the present invention is an image adjustment method including: a two-dimensional luminance histogram deriving step of deriving a statistic from a first pixel having a first luminance and a second pixel having a second luminance co-occurring in a local region in an input image, and deriving a two-dimensional luminance histogram having the statistic as a numerical value corresponding to the first luminance and the second luminance; a one-dimensional luminance histogram deriving step of deriving a numerical value by weighting the two-dimensional luminance histogram derived by the two-dimensional luminance histogram deriving step by using a weighting coefficient determined according to a third luminance greater than the first luminance and less than or equal to the second luminance, and deriving a one-dimensional luminance histogram having the numerical value as a numerical value corresponding to the third luminance; and a luminance converting step of deriving a luminance conversion function to cause the one-dimensional luminance histogram derived by the one-dimensional luminance histogram deriving step to be converted into a predetermined histogram, and converting a luminance of each of pixels of the input image by using the luminance conversion function.

One aspect of the present invention is a program for causing a computer to execute the image adjustment method.

One aspect of the present invention is an image adjustment device including: a two-dimensional luminance histogram deriving unit that derives a statistic from a first pixel having a first luminance and a second pixel having a second luminance co-occurring in a local region in an input image, and derives a two-dimensional luminance histogram having the statistic as a numerical value corresponding to the first luminance and the second luminance; a one-dimensional luminance histogram deriving unit that derives a numerical value by weighting the two-dimensional luminance histogram derived by the two-dimensional luminance histogram deriving unit by using a weighting coefficient determined according to a third luminance greater than the first luminance and less than or equal to the second luminance, and derives a one-dimensional luminance histogram having the numerical value as a numerical value corresponding to the third luminance; and a luminance converting unit that derives a luminance conversion function to cause the one-dimensional luminance histogram derived by the one-dimensional luminance histogram deriving unit to be converted into a predetermined histogram, and converts a luminance of each of pixels of the input image by using the luminance conversion function.

### Advantageous Effects of Invention

According to the present invention, it is possible to more suitably edit an image.

### BRIEF DESCRIPTION OF DRAWINGS

FIG. 1 is a block diagram illustrating a configuration of an image adjustment device.

FIG. 2 is a block diagram illustrating a configuration of a two-dimensional luminance histogram deriving unit.

FIG. 3 is a graph illustrating derived p(c_{i, j}).

FIG. 4 is a block diagram illustrating a configuration of a one-dimensional luminance histogram deriving unit.

FIG. 5 is a diagram illustrating a one-dimensional luminance histogram derived from a two-dimensional luminance histogram.

FIG. 6 is a diagram illustrating a luminance conversion function derived from the one-dimensional luminance histogram.

FIG. 7 is a flowchart illustrating a flow of processing.

### DESCRIPTION OF EMBODIMENTS

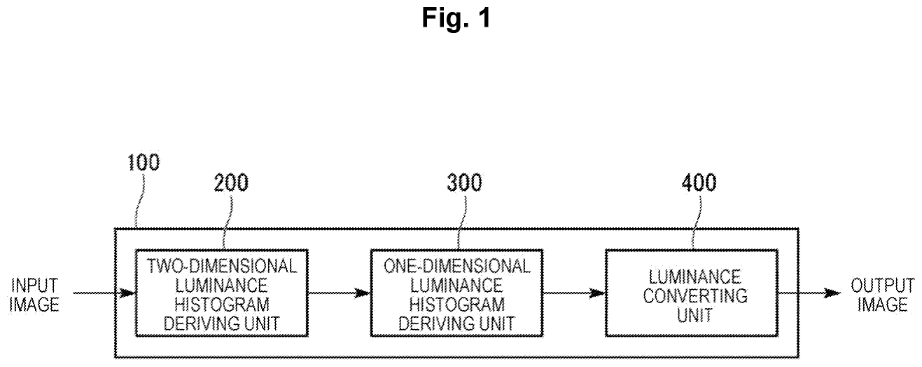

An embodiment of the present invention will be described in detail with reference to the drawings. FIG. 1 is a block diagram illustrating a configuration of an image adjustment device 100 according to the embodiment. The image adjustment device 100 is a device that adjusts an inputted input image and outputs the adjusted input image as an output image. The input image is a grayscale image. The output image is an image obtained by enhancing the input image. Specifically, it is an image obtained as a result of enlarging contrast of the input image and revealing hidden details in the input image.

In a case where the present embodiment is applied to a grayscale image, the grayscale image is used as an input image. In a case where the present embodiment is applied to a color image, a grayscale image is derived from the color image, and the grayscale image is used as an input image. For example, a V component image of a color image in an HSV color space is derived as a grayscale image. Since the image adjustment device 100 adjusts only the grayscale image derived from the color image, the output image does not include color information. In a case where an image including color information is set as an output image, the V component image of the color image is replaced with an adjusted image in the HSV color space.

Image adjustment device 100 includes a two-dimensional luminance histogram deriving unit 200, a one-dimensional luminance histogram deriving unit 300, and a luminance converting unit 400.

The two-dimensional luminance histogram deriving unit 200 derives a statistic from a first pixel having a first luminance and a second pixel having a second luminance co-occurring in a local region in the input image, and derives a two-dimensional luminance histogram having the statistic as a numerical value corresponding to the first luminance and the second luminance. The one-dimensional luminance histogram deriving unit 300 derives a numerical value by weighting the two-dimensional luminance histogram derived by the two-dimensional luminance histogram deriving unit 200 by using a weighting coefficient determined according to a third luminance greater than the first luminance and less than or equal to the second luminance, and derives a one-dimensional luminance histogram having the numerical value as a numerical value corresponding to the third luminance. The luminance converting unit 400 derives a luminance conversion function to cause the one-dimensional luminance histogram derived by the one-dimensional luminance histogram deriving unit 300 to be converted into a predetermined histogram, and converts a luminance of each of pixels of the input image by using the luminance conversion function. Hereinafter, details of these will be described.

The two-dimensional luminance histogram deriving unit 200 inputs the input image and outputs the two-dimensional luminance histogram to the one-dimensional luminance histogram deriving unit 300. The input image is set as A={a(q)}. The a(q)∈[0, K) is a luminance of a pixel at a coordinate q of the input image. K is the total number of luminances that can be taken by pixels of the grayscale image, and K=256 is set in the present embodiment.

In the input image, an event is set as c_{i, j} in which a second luminance j∈[0, K) appears in a local region centered on a pixel having a first luminance i∈[0, K). That is, c_{i, j} is an event in which the first luminance i and the second luminance j co-occur in the local region of the input image.

The two-dimensional luminance histogram deriving unit 200 sets, as p(c_{i, j}), a probability occurs that an event in which the first luminance i and the second luminance j co-occur in the local region of the input image, and sets the probability as a statistic, that is, a histogram value for a pair of the first luminance i and the second luminance j. The two-dimensional luminance histogram deriving unit 200 sets a set of these histogram values as the two-dimensional luminance histogram.

For each of pairs of the first luminance i and the second luminance j, it is desirable that the two-dimensional luminance histogram deriving unit 200 derives the two-dimensional luminance histogram so that the histogram value p(c_{i, j}) for the pair of the first luminance i and the second luminance j increases as a desired degree of contrast enhancement increases.

That is, it is desirable that the histogram value of the two-dimensional luminance histogram accurately represents the desired degree of contrast enhancement. In the following description, how much the contrast between the two luminances is enlarged by the luminance conversion function is expressed as “actual degree of contrast enhancement”. What degree the actual degree of contrast enhancement is desirable in the two luminances is expressed as “desired degree of contrast enhancement”.

The two-dimensional luminance histogram deriving unit 200 derives a difference between the first luminance i and the second luminance j from each of pairs of the first pixel and the second pixel co-occurring in the local region of the input image, sets a numerical value obtained as a result of integrating differences of the pairs as a probability p(ci, j) that an event occurs in which the first luminance i and the second luminance j co-occur in the local region of the input image, and sets the probability as the histogram value for the pair of the first luminance i and the second luminance j. The two-dimensional luminance histogram deriving unit 200 derives a set of these histogram values as the two-dimensional luminance histogram.

Specifically, the two-dimensional luminance histogram deriving unit 200 derives the two-dimensional luminance histogram as follows. The input image is set as A={a(q)}. The a(q)∈[0, K) is a luminance of a pixel at the coordinate q of the input image. The two-dimensional luminance histogram deriving unit derives the histogram value p(c_{i, j}) for each of the pairs of the first luminance i and the second luminance j by using the following (1).

$$\begin{matrix}[ Math . 1 ] & \\ p ( {c}_{i , j} ) = \frac{{\sum }_{q ∈ A} {\sum }_{{q}^{′} ∈ N ( q )} \vert a ( q ) - a ( {q}^{′} ) \vert \times δ ( a ( q ) , i ) \times δ ( a ( {q}^{′} ) , j )}{{\sum }_{q ∈ A} {\sum }_{{q}^{′} ∈ N ( q )} \vert a ( q ) - a ( {q}^{′} ) \vert} & ( 1 )\end{matrix}$$

Here, N(q) is a set of coordinates in the local region centered on the coordinate q, and the size of the local region is, for example, 7×7. The δ(x, y) is Kronecker delta, and is 1 in the case of x=y and 0 in the case of x≠y. The two-dimensional luminance histogram deriving unit 200 derives the histogram value p(c_{i, j}) for each of the pairs of the first luminance i and the second luminance j, and then derives a set of these histogram values as the two-dimensional luminance histogram.

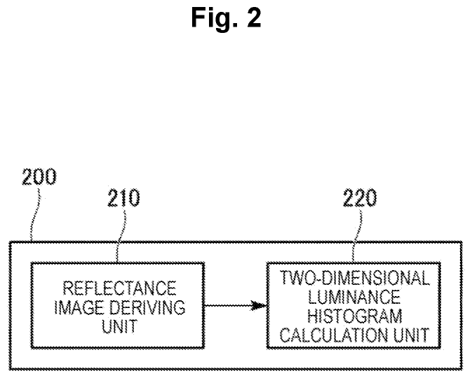

Next, an example will be described of deriving the two-dimensional luminance histogram by using a reflectance image instead of deriving the statistic according to the above (1). FIG. 2 is a block diagram illustrating a configuration of the two-dimensional luminance histogram deriving unit 200 in a case where the two-dimensional luminance histogram is derived by using the reflectance image. The two-dimensional luminance histogram deriving unit 200 includes a reflectance image deriving unit 210 and a two-dimensional luminance histogram calculation unit 220. The reflectance image deriving unit 210 derives the reflectance image from the input image and outputs the reflectance image to the two-dimensional luminance histogram calculation unit 220. The two-dimensional luminance histogram calculation unit 220 derives the two-dimensional luminance histogram by calculating the two-dimensional luminance histogram by using the input image and the reflectance image.

The reflectance image deriving unit 210 uses an illumination image obtained by smoothing the input image, and derives an image obtained by removing the illumination image from the input image, as the reflectance image. Specifically, the reflectance image is derived as follows. In the present embodiment, the reflectance image deriving unit 210 derives the illumination image by using a method described in “Structure Extraction from Texture via Relative Total Variation, Li Xu et al., ACM Transactions on Graphics, Vol. 31, No. 6, Article 139, Publication Date: November 2012”.

In this method, a ratio between an average of absolute values of a first derivative of the luminance and an absolute value of an average of first derivatives of the luminance in a local region around each pixel is set as an intensity of texture for each pixel. The illumination image is optimized so that the sum of a difference between the input image and the illumination image and an intensity of texture of the illumination image is minimized. Note that, instead of the above method, the illumination image may be derived by using a median filter, a bilateral filter, a guided filter, or an anisotropic diffusion filter.

The illumination image and the reflectance image of an input image A are denoted by I and R, respectively. The reflectance image is derived by using the following (2).

$$\begin{matrix}[ Math . 2 ] & \\ R = ln ( A ⌀ I ) & ( 2 )\end{matrix}$$

Here, ln(·) is a natural logarithm. In addition, an operator indicated in an antilogarithm part of the logarithm indicates that the elements of a matrix A are divided by corresponding elements of a matrix I. Instead of the natural logarithm, a logarithm based on any real number greater than 1 may be used to derive the reflectance image. By using a logarithmic function that enlarges a small amount of difference, it is possible to enlarge a difference in reflectance for a dark image region that is often semantically important. That is, using the logarithmic function is effective for deriving the reflectance image. Here, the reflectance is a pixel value of a pixel in the reflectance image.

A method of deriving the reflectance image only needs to be a method of removing the illumination image from the input image, and is not limited to a specific method. For example, an image obtained as a result of dividing each pixel value of the input image by a corresponding pixel value of the illumination image may be used as the reflectance image. That is, the reflectance image may be derived by the following (3).

$$\begin{matrix}[ Math . 3 ] & \\ R = A ⌀ I & ( 3 )\end{matrix}$$

When the reflectance image is derived by the reflectance image deriving unit 210 in this manner, the two-dimensional luminance histogram is calculated by the two-dimensional luminance histogram calculation unit 220. A pixel of the input image having the first luminance i is set as the first pixel, and a pixel of the input image having the second luminance j is set as the second pixel. A pixel value of a pixel of the reflectance image at the same position as the first pixel is set as a first reflectance, and a pixel value of a pixel of the reflectance image at the same position as the second pixel is set as a second reflectance.

For each of the pairs of the first luminance i and the second luminance j, the two-dimensional luminance histogram calculation unit 220 derives a difference between the first reflectance and the second reflectance from each of the pairs of the first pixel and the second pixel co-occurring in the local region of the input image, and sets a numerical value obtained as a result of integrating differences of the pairs as the histogram value p(c_{i, j}) for the pair of the first luminance and the second luminance. A set of these histogram values is derived as the two-dimensional luminance histogram.

Specifically, the two-dimensional luminance histogram is derived as follows. The reflectance image is set as R={r(q)}. The r(q) is a pixel value of a pixel at the coordinate q of the reflectance image. The two-dimensional luminance histogram calculation unit derives the histogram value p(c_{i, j}) for each of the pairs of the first luminance i and the second luminance j by the following (4).

$$\begin{matrix}[ Math . 4 ] & \\ p ( {c}_{i , j} ) = \frac{{\sum }_{q ∈ A} {\sum }_{{q}^{′} ∈ N ( q )} \vert r ( q ) - r ( {q}^{′} ) \vert \times δ ( a ( q ) , i ) \times δ ( a ( {q}^{′} ) , j )}{{\sum }_{q ∈ A} {\sum }_{{q}^{′} ∈ N ( q )} \vert r ( q ) - r ( {q}^{′} ) \vert} & ( 4 )\end{matrix}$$

Here, N(q) is a set of coordinates in the local region centered on the coordinate q, and in the present embodiment, the size of the local region is 7×7. The δ(x, y) is Kronecker delta, and is 1 in the case of x=y and 0 in the case of x≠y. The two-dimensional luminance histogram deriving unit 200 derives the histogram value p(c_{i, j}) for each of the pairs of the first luminance i and the second luminance j, and then derives a set of these histogram values as the two-dimensional luminance histogram. As described above, the two-dimensional luminance histogram deriving unit 200 derives the two-dimensional luminance histogram by deriving the statistic on the basis of the difference between the first luminance and the second luminance.

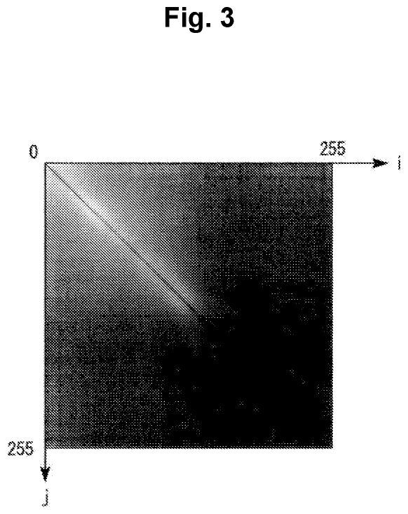

FIG. 3 is a graph illustrating p(c_{i, j}) derived from the above (4) for the input image. In the graph illustrated in FIG. 3, the upper left is the origin, the horizontal axis indicates i, and the vertical axis indicates j. In addition, in the graph of FIG. 3, the larger p(c_{i, j}) is, the whiter it is displayed.

An effect will be described obtained by deriving the two-dimensional luminance histogram using the reflectance image. First, in a semantically important image region such as an image region in which a main subject is captured or an area other than the background, a texture or a pattern is often included, and a difference between pixel values in the reflectance image is often large. In an image region that is not semantically important, such as a background without texture or quantization noise of the image, the difference between pixel values in the reflectance image is often small.

Thus, the two-dimensional luminance histogram is derived by using the reflectance image, whereby the histogram value is calculated to be larger for a pair of luminances co-occurring in the semantically important image region in the two-dimensional luminance histogram. In addition, in a pair of luminance co-occurring in the image region that is not semantically important, the histogram value is calculated to be smaller. Thus, the histogram value of the two-dimensional luminance histogram can accurately represent the desired degree of contrast enhancement.

Next, the one-dimensional luminance histogram deriving unit 300 will be described. The one-dimensional luminance histogram deriving unit 300 acquires the two-dimensional luminance histogram from the two-dimensional luminance histogram deriving unit 200, and outputs the one-dimensional luminance histogram to the luminance converting unit 400.

In the input image, an event in which a third luminance k∈[0, K) appears is set as oₖ. A probability that the event occurs is set as p(oₖ), and set as a histogram value for the third luminance k. A set of these histogram values is set as the one-dimensional luminance histogram. As will be described later, according to the luminance converting unit 400, for each of third luminances k, the actual degree of contrast enhancement for a pair of a luminance k−1 and a luminance k is directly proportional to the histogram value p(oₖ) of the one-dimensional luminance histogram for the third luminance k.

Thus, for each of the pairs of the first luminance i and the second luminance j, the actual degree of contrast enhancement is directly proportional to the sum of histogram values p(oₖ) of the one-dimensional luminance histograms for all the third luminance k greater than the first luminance i and less than or equal to the second luminance j. That is, for each of the pairs of the first luminance i and the second luminance j, the actual degree of contrast enhancement is directly proportional to the following (5).

$$\begin{matrix}[ Math . 5 ] & \\ {\sum }_{k = i + 1}^{j} p ( {o}_{k} ) & ( 5 )\end{matrix}$$

On the other hand, in the present embodiment, the histogram value of the two-dimensional luminance histogram represents the desired degree of contrast enhancement. Here, if the actual degree of contrast enhancement is directly proportional to the histogram value of the two-dimensional luminance histogram, the actual degree of contrast enhancement matches the desired degree of contrast enhancement, and the contrast of the input image can be enhanced as desired.

According to the above consideration, it is desirable that the one-dimensional luminance histogram deriving unit 300 derives the one-dimensional luminance histogram so that, for each of the pairs of the first luminance i and the second luminance j, the sum of the histogram values p(oₖ) of the one-dimensional luminance histograms for all the third luminance k greater than the first luminance i and less than or equal to the second luminance j is directly proportional to the histogram value p(c_{i, j}) of the two-dimensional luminance histogram for the pair of the first luminance i and the second luminance j.

That is, it is desirable that the one-dimensional luminance histogram deriving unit 300 derives the one-dimensional luminance histogram so that a condition shown in the following (6) is satisfied for each of the pairs of the first luminance i and the second luminance j.

$$\begin{matrix}[ Math . 6 ] & \\ {\sum }_{k = i + 1}^{j} p ( {o}_{k} ) ∝ p ( {c}_{i , j} ) & ( 6 )\end{matrix}$$

For this reason, in the present embodiment, it is assumed that the event oₖ in which the third luminance k appears and the event c_{i, j} in which the first luminance i smaller than the third luminance k and the second luminance j greater than or equal to the third luminance k co-occur in the local region in the input image depend on each other. Thus, if the event oₖ is a peripheral event, the probability p(oₖ) of the event oₖ can be derived by marginalizing p(c_{i, j}).

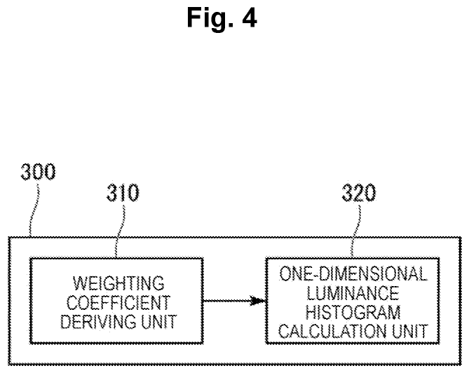

An actual derivation example will be described. FIG. 4 is a block diagram illustrating a configuration of the one-dimensional luminance histogram deriving unit 300. The one-dimensional luminance histogram deriving unit 300 includes a weighting coefficient deriving unit 310 and a one-dimensional luminance histogram calculation unit 320.

The weighting coefficient deriving unit 310 outputs the weighting coefficient to the one-dimensional luminance histogram calculation unit 320. The weighting coefficient deriving unit 310 calculates a priority coefficient sₖ in advance for each of the third luminances k. For example, the same real number is set as the priority coefficient sₖ. Next, for each of pieces of a triplet of the third luminance k, the first luminance i smaller than the third luminance k, and the second luminance j greater than or equal to the third luminance k, the weighting coefficient deriving unit 310 divides the priority coefficient sₖ of the third luminance k by the sum of the priority coefficients of all the luminances greater than the first luminance i and less than or equal to the second luminance j. The weighting coefficient deriving unit 310 derives a division result as the weighting coefficient in the triplet.

Specifically, the weighting coefficient is derived as follows. In the present embodiment, the weighting coefficient deriving unit 310 sets the same real number 1/K as the priority coefficient sₖ for each of the third luminances k. That is, sₖ=1/K is set. As described above, K is the total number of luminance that can be taken by the pixels of the grayscale image. Next, for each of pieces of the triplet of the third luminance k, the first luminance i smaller than the third luminance k, and the second luminance j greater than or equal to the third luminance k, the weighting coefficient deriving unit 310 derives a weighting coefficient p(oₖ|c_{i, j}) in the triplet by the following (7).

$$\begin{matrix}[ Math . 7 ] & \\ p ( {o}_{k} \vert {c}_{i , j} ) = \frac{{s}_{k}}{{\sum }_{{k}^{′} = i + 1}^{j} {s}_{{k}^{′}}} & ( 7 )\end{matrix}$$

The one-dimensional luminance histogram calculation unit 320 acquires the two-dimensional luminance histogram from the two-dimensional luminance histogram deriving unit 200, acquires the weighting coefficient from the weighting coefficient deriving unit 310, and outputs the one-dimensional luminance histogram to the luminance converting unit 400.

For each of the third luminances k, the one-dimensional luminance histogram calculation unit 320 derives a weighted sum by using the weighting coefficient p(oₖ|c_{i, j}) for the histogram value p(c_{i, j}) of the two-dimensional luminance histogram for the pair of the first luminance i smaller than the third luminance k and the second luminance j greater than or equal to the third luminance k. The one-dimensional luminance histogram calculation unit 320 sets the derived weighted sum as the histogram value p(oₖ) of the one-dimensional luminance histogram for the third luminance k. A set of these histogram values is derived as the one-dimensional luminance histogram.

Specifically, the one-dimensional luminance histogram is derived as follows. For each of the third luminances k, the one-dimensional luminance histogram calculation unit 320 derives the histogram value p(oₖ) of the one-dimensional luminance histogram by the following (8).

$$\begin{matrix}[ Math . 8 ] & \\ p ( {o}_{k} ) = {\sum }_{i = 0}^{k - 1} {\sum }_{j = k}^{K - 1} p ( {o}_{k} \vert {c}_{i , j} ) p ( {c}_{i , j} ) & ( 8 )\end{matrix}$$

Here, the weighting coefficient p(oₖ|c_{i, j}) is a conditional probability, and is a probability of the event oₖ when the event c_{i, j} occurs. The above (8) indicates that the event oₖ is a peripheral event, and the probability p(oₖ) of the event oₖ is derived by marginalizing p(c_{i, j}). After deriving the histogram value p(oₖ) of the one-dimensional luminance histogram for each of the third luminances k, the one-dimensional luminance histogram calculation unit 320 derives a set of these histogram values as the one-dimensional luminance histogram.

Another derivation example for the one-dimensional luminance histogram will be described. The one-dimensional luminance histogram deriving unit 300 may derive the one-dimensional luminance histogram by using the following iterative method. Specifically, the weighting coefficient deriving unit 310 outputs the weighting coefficient to the one-dimensional luminance histogram calculation unit 320 in the first iteration. In the second and subsequent iterations, the weighting coefficient deriving unit 310 acquires the one-dimensional luminance histogram derived in the previous iteration from the one-dimensional luminance histogram calculation unit 320, and outputs the weighting coefficient to the one-dimensional luminance histogram calculation unit 320.

In the first iteration, the weighting coefficient deriving unit 310 calculates an initial value of the priority coefficient sₖ for each of the third luminances k. For example, the same real number is set as the priority coefficient sₖ. Next, for each of pieces of a triplet of the third luminance k, the first luminance i smaller than the third luminance k, and the second luminance j greater than or equal to the third luminance k, the weighting coefficient deriving unit 310 divides the priority coefficient sₖ of the third luminance k by the sum of the priority coefficients of all the luminances greater than the first luminance i and less than or equal to the second luminance j. The weighting coefficient deriving unit 310 derives a division result as the weighting coefficient in the triplet.

As described above, the one-dimensional luminance histogram deriving unit 300 derives the priority coefficient for each third luminance. The one-dimensional luminance histogram deriving unit 300 sets a weighting coefficient corresponding to the first luminance, the second luminance, and the third luminance, as a division result. The division result here is a division result obtained by dividing the priority coefficient corresponding to the third luminance by the sum of the priority coefficients corresponding to all the luminances greater than the first luminance and less than or equal to the second luminance.

Specifically, the weighting coefficient is derived as follows. In the present embodiment, the weighting coefficient deriving unit 310 sets the same real number 1/K as the priority coefficient sₖ for each of the third luminances k. That is, sₖ=1/K is set.

In the second and subsequent iterations, for each of the third luminances k, the histogram value of the one-dimensional luminance histogram derived in the previous iteration is set as the priority coefficient sₖ of the third luminance k. Next, for each of pieces of the triplet of the third luminance k, the first luminance i smaller than the third luminance k, and the second luminance j greater than or equal to the third luminance k, the weighting coefficient p(oₖ|c_{i, j}) in the triplet is derived by the above (7).

The one-dimensional luminance histogram calculation unit 320 acquires the two-dimensional luminance histogram from the two-dimensional luminance histogram deriving unit 200, acquires the weighting coefficient from the weighting coefficient deriving unit 310, and outputs the one-dimensional luminance histogram to the weighting coefficient deriving unit 310 until the number of iterations reaches a maximum number of iterations. When the number of iterations reaches a predetermined maximum number of iterations, the one-dimensional luminance histogram calculation unit 320 outputs the one-dimensional luminance histogram to the luminance converting unit 400.

For each of the third luminances k, the one-dimensional luminance histogram calculation unit 320 derives a weighted sum by using the weighting coefficient p(oₖ|c_{i, j}) for the histogram value p(c_{i, j}) of the two-dimensional luminance histogram for the pair of the first luminance i smaller than the third luminance k and the second luminance j greater than or equal to the third luminance k. The one-dimensional luminance histogram calculation unit 320 sets the derived weighted sum as the histogram value p(oₖ) of the one-dimensional luminance histogram for the third luminance k. A set of these histogram values is derived as the one-dimensional luminance histogram.

For each of the third luminances k, the one-dimensional luminance histogram calculation unit 320 derives the histogram value p(oₖ) of the one-dimensional luminance histogram by the above (8). After the histogram value p(oₖ) of the one-dimensional luminance histogram is derived for each of the third luminances k, a set of these histogram values is derived as the one-dimensional luminance histogram.

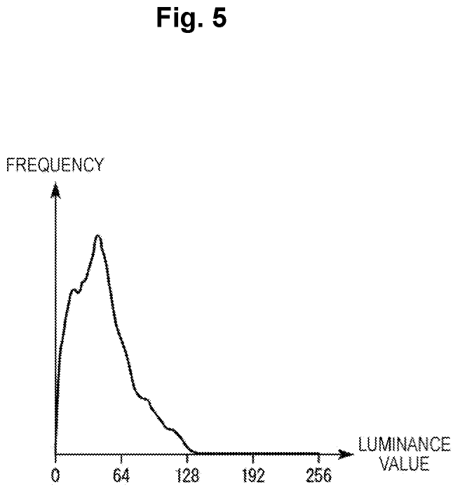

The one-dimensional luminance histogram calculation unit 320 repeats the above-described processing until the number of iterations reaches the maximum number of iterations. When the number of iterations reaches the maximum number of iterations, the one-dimensional luminance histogram derived by the last iteration is output to the luminance converting unit 400. The maximum number of iterations of about two or three is sufficient, and in the present embodiment, the maximum number of iterations is set to two. FIG. 5 is a diagram illustrating a one-dimensional luminance histogram derived from the two-dimensional luminance histogram illustrated in FIG. 3. In FIG. 5, the horizontal axis represents the luminance value, and the vertical axis represents the frequency.

According to the one-dimensional luminance histogram deriving unit 300 using the iterative method, the priority coefficient of the third luminance increases as the histogram value of the one-dimensional luminance histogram derived in the previous iteration increases, and the histogram value of the one-dimensional luminance histogram derived in the current iteration can acquire more image information from the two-dimensional luminance histogram. That is, it is possible to more accurately derive the one-dimensional luminance histogram.

Next, the luminance converting unit 400 will be described. The luminance converting unit 400 acquires the input image, acquires the one-dimensional luminance histogram from the one-dimensional luminance histogram deriving unit 300, and outputs the output image. The luminance converting unit 400 derives the luminance conversion function for converting the luminance so that the one-dimensional luminance histogram is converted into the predetermined histogram. The luminance conversion function is used, and an image obtained as a result of converting the luminance of each pixel of the input image is derived as the output image. Note that, in the present embodiment, a uniform distribution function is set as the predetermined histogram.

The input image is set as A={a(q)}. The output image is set as B={b(q)}. The a(q)∈[0, K) and the b(q)∈[0, K) are luminances of pixels at the coordinate q of the input image and the output image, respectively. The luminance converting unit derives a luminance conversion function T(·) in the form of b(q)=T(a(q)). The luminance conversion function T(·) is used, and an image obtained as a result of converting the luminance a(q) of each pixel q of the input image A is derived as the output image B. Specifically, the output image is derived as follows.

A cumulative distribution function of the one-dimensional luminance histogram p(oₖ) for the input image A is set as Pₐ(k), and a cumulative distribution function of the predetermined histogram is set as P_{b}(k). The luminance converting unit derives the luminance conversion function T(·) by Expression 9. Here, P⁻¹_{b}(·) is an inverse function of the cumulative distribution function P_{b}(k).

$$\begin{matrix}[ Math . 9 ] & \\ \begin{matrix}T ( k ) = arg {min}_{T} \vert {P}_{b} ( T ( k ) ) - {P}_{a} ( k ) \vert \\ = {P}_{b}^{- 1} ( {P}_{a} ( k ) )\end{matrix} & ( 9 )\end{matrix}$$

As described above, in the present embodiment, the uniform distribution function is set as the predetermined histogram. In this case, processing of the luminance converting unit 400 is equivalent to histogram equalization, and the above (9) is the following (10).

$$\begin{matrix}[ Math . 10 ] & \\ T ( k ) = {KP}_{a} ( k ) - 1 & ( 10 )\end{matrix}$$

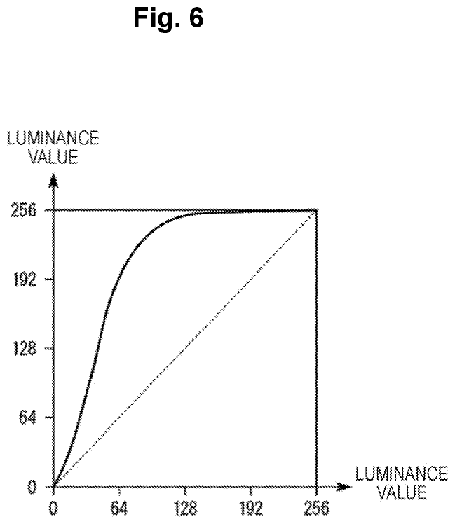

FIG. 6 is a diagram illustrating a luminance conversion function derived from the one-dimensional luminance histogram of FIG. 5. In FIG. 6, the horizontal axis represents the luminance value before conversion, and the vertical axis represents the luminance value after conversion. Note that, instead of the uniform distribution function, a logarithmic function, a linear function, or the like may be used as the predetermined histogram. After the luminance conversion function T(·) is derived, the image obtained as a result of converting the luminance a(q) of each pixel q of the input image A is derived as the output image B by b(q)=T(a(q)).

Note that, in a case where the luminance conversion function is derived by the above (10), for each of the third luminances k, the actual degree of contrast enhancement for the pair of the luminance k−1 and the luminance k is the following (11), and is directly proportional to the histogram value p(oₖ) of the one-dimensional luminance histogram for the third luminance k.

$$\begin{matrix}[ Math . 11 ] & \\ \begin{matrix}T ( k ) - T ( k - 1 ) = K ( {P}_{a} ( k ) - {P}_{a} ( k - 1 ) ) \\ = Kp ( {o}_{k} )\end{matrix} & ( 11 )\end{matrix}$$

Thus, for each of the pairs of the first luminance i and the second luminance j, the actual degree of contrast enhancement is directly proportional to the sum of histogram values p(oₖ) of the one-dimensional luminance histograms for all the third luminance k greater than the first luminance i and less than or equal to the second luminance j. That is, for each of the pairs of the first luminance i and the second luminance j, the actual degree of contrast enhancement is directly proportional to the above (5).

According to the one-dimensional luminance histogram deriving unit 300 and the luminance converting unit 400 described above, for each of the pairs of the first luminance and the second luminance, the actual degree of contrast enhancement is directly proportional to the histogram value of the two-dimensional luminance histogram for the pair of the first luminance and the second luminance. Thus, if the histogram value of the two-dimensional luminance histogram can accurately represent the desired degree of contrast enhancement, the contrast of the input image can be enhanced as desired. As a result, by adjusting the histogram value of the two-dimensional luminance histogram in the image region that is not semantically important, it is possible to implement image enhancement while suppressing excessive enhancement of the contrast.

In addition, according to the two-dimensional luminance histogram deriving unit 200 and the one-dimensional luminance histogram deriving unit 300, even in a case where a very small (dark) first luminance and a very large (bright) second luminance frequently co-occur in the local region of the input image, these luminances are not excessively drawn to the center of the luminance range, and more correct luminance conversion can be performed. Thus, it is possible to implement image enhancement without attenuating the contrast near the center of the luminance range.

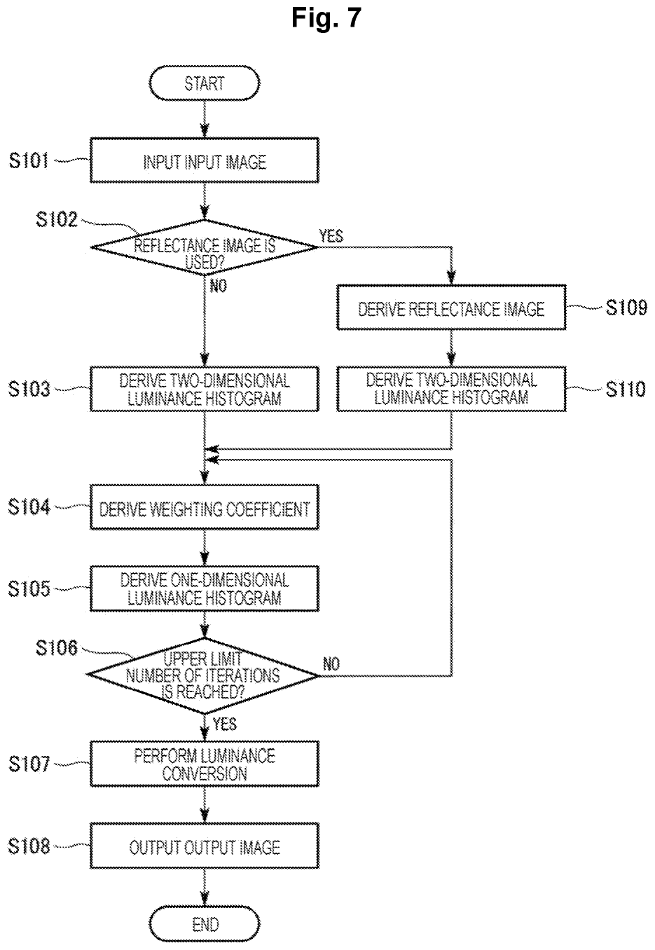

FIG. 7 is a flowchart illustrating a flow of the processing described above. The input image is input to the image adjustment device 100 (step S101). When deriving the two-dimensional luminance histogram, the image adjustment device 100 determines whether or not to use the reflectance image (step S102). For example, a storage device (not illustrated) in which contents set by a user are stored is referred to, whereby whether or not to use the reflectance image is determined.

In a case where the reflectance image is not used (step S102: NO), the image adjustment device 100 derives the two-dimensional luminance histogram by using the above (1) (step S103), and proceeds to step S104. In a case where the reflectance image is used (step S102: YES), the image adjustment device 100 derives the reflectance image (step S109). The image adjustment device 100 derives the two-dimensional luminance histogram by using the above (4) (step S103), and proceeds to step S104.

The image adjustment device 100 derives the weighting coefficient (step S104). The image adjustment device 100 derives the one-dimensional luminance histogram (step S105). The image adjustment device 100 determines whether or not an upper limit number of iterations is reached (step S106). For example, the storage device (not illustrated) in which contents set by the user are stored is referred to, whereby the upper limit number of iterations is acquired. In a case where the upper limit number of iterations is one, it indicates that the iterative method is not performed.

In a case where the upper limit number of iterations is not reached (step S106: NO), the image adjustment device 100 derives the weighting coefficient again in step S104 by using a numerical value corresponding to the third luminance in the one-dimensional luminance histogram derived in step S105 as the priority coefficient corresponding to the third luminance. On the other hand, in a case where the upper limit number of iterations is reached or the upper limit number of iterations is one (step S106: YES), the image adjustment device 100 performs luminance conversion (step S107), outputs the image subjected to the luminance conversion as the output image (step S108), and ends the processing.

In the embodiment described above, the image adjustment device 100 may be configured by using a processor such as a central processing unit (CPU) and a memory. In this case, the processor executes a program, whereby the image adjustment device 100 functions as the image adjustment device 100. Note that all or some of each function of the image adjustment device 100 may be implemented by using hardware such as an application specific integrated circuit (ASIC), a programmable logic device (PLD), or a field programmable gate array (FPGA). The program may be recorded in a computer-readable recording medium. Examples of the computer-readable recording medium include a portable medium such as a flexible disk, a magneto-optical disk, a ROM, a CD-ROM, or a semiconductor storage device (for example, a solid state drive (SSD)), and a storage device such as a hard disk or a semiconductor storage device built in a computer system. The program may be transmitted via an electric communication line.

Although the embodiment of this invention has been described in detail with reference to the drawings, specific configurations are not limited to this embodiment, and include design and the like within a range without departing from the gist of this invention.

### INDUSTRIAL APPLICABILITY

The present invention is applicable to a device that enhances an image and software that edits an image.

### REFERENCE SIGNS LIST

100 image adjustment device
200 two-dimensional luminance histogram deriving unit
210 reflectance image deriving unit
220 two-dimensional luminance histogram calculation unit
300 one-dimensional luminance histogram deriving unit
310 weighting coefficient deriving unit
320 one-dimensional luminance histogram calculation unit
400 luminance converting unit

1. An image adjustment method comprising:
a two-dimensional luminance histogram deriving step of deriving a statistic from a first pixel having a first luminance and a second pixel having a second luminance co-occurring in a local region in an input image, and deriving a two-dimensional luminance histogram having the statistic as a numerical value corresponding to the first luminance and the second luminance;
a one-dimensional luminance histogram deriving step of deriving a numerical value by weighting the two-dimensional luminance histogram derived by the two-dimensional luminance histogram deriving step by using a weighting coefficient determined according to a third luminance greater than the first luminance and less than or equal to the second luminance, and deriving a one-dimensional luminance histogram having the numerical value as a numerical value corresponding to the third luminance; and
a luminance converting step of deriving a luminance conversion function to cause the one-dimensional luminance histogram derived by the one-dimensional luminance histogram deriving step to be converted into a predetermined histogram, and converting a luminance of each of pixels of the input image by using the luminance conversion function.

2. The image adjustment method according to claim 1, wherein the two-dimensional luminance histogram deriving step derives the two-dimensional luminance histogram by deriving the statistic on a basis of a difference between the first luminance and the second luminance.

3. The image adjustment method according to claim 1, wherein the two-dimensional luminance histogram deriving step derives the two-dimensional luminance histogram by using a reflectance image obtained by removing an image obtained by smoothing the input image from the input image.

4. The image adjustment method according to claim 1, wherein the one-dimensional luminance histogram deriving step derives a priority coefficient for each of a plurality of the third luminances, and sets a weighting coefficient corresponding to the first luminance, the second luminance, and the third luminance to a division result obtained by dividing the priority coefficient corresponding to the third luminance by a sum of priority coefficients corresponding to all luminances greater than the first luminance and less than or equal to the second luminance.

5. The image adjustment method according to claim 4, wherein the one-dimensional luminance histogram deriving step derives a weighting coefficient again by using the numerical value corresponding to the third luminance in the derived one-dimensional luminance histogram as the priority coefficient corresponding to the third luminance.

6. A non-transitory computer-readable medium having computer-executable instructions that, upon execution of the instructions by a processor of a computer, cause the computer to function as the image adjustment method according to claim 1.

7. An image adjustment device comprising:
a processor; and
a storage medium having computer program instructions stored thereon, when executed by the processor, perform to:
derives a statistic from a first pixel having a first luminance and a second pixel having a second luminance co-occurring in a local region in an input image, and derives a two-dimensional luminance histogram having the statistic as a numerical value corresponding to the first luminance and the second luminance;
derives a numerical value by weighting the two-dimensional luminance histogram derived by the two-dimensional luminance histogram deriving unit by using a weighting coefficient determined according to a third luminance greater than the first luminance and less than or equal to the second luminance, and derives a one-dimensional luminance histogram having the numerical value as a numerical value corresponding to the third luminance; and
derives a luminance conversion function to cause the one-dimensional luminance histogram derived by the one-dimensional luminance histogram deriving unit to be converted into a predetermined histogram, and converts a luminance of each of pixels of the input image by using the luminance conversion function.
